(19) United States
(12) Patent Application Publication
(10) Pub. No.: US 2002/0069769 A1
(43) Pub. Date: Jun. 13, 2002

(54) Garlic press

(76) Inventor: Bruno Herren, Bern (CH)

Correspondence Address: Pauley Petersen Kinne & Fejer, 2800 W. Higgins Road, Suite 365, Hoffman Estates, IL, 60195, US

(21) Appl. No.: 09/964,282

(22) Filed: Sep. 26, 2001

(30) Foreign Application Priority Data
Sep. 26, 2000 (CH) 2000 1889/00

(51) Int. Cl. B30B 9/02

(52) U.S. Cl. 100/125; 100/234

(57) ABSTRACT

A plier-like garlic press having an upper grip and a lower grip. Both grips are connected to one another via a pivot. On the upper grip is formed a head in which a pressing plunger is linkedly mounted. The pressing plunger presses with a pressing plunger plate on a sieve-like, perforated base plate. The base plate is mounted separably on the lower end of the chamber which accommodates the product to be pressed. Preferably the sieve-like, perforated base plate is formed as an insertable element with a lock. The garlic press may be easily cleaned by removing the perforated base plate.

### BACKGROUND OF THE INVENTION

1. Field of the Invention

This invention relates to a garlic press having two hand grips which are connected to one another like pliers, wherein a lower grip has a chamber that accommodates product to be pressed and has a sieve-like, perforated base, and an upper grip is connected to a pressing plunger that immerses into the receptacle.

2. Description of Related Art

Garlic presses of this construction type have been available in the market. One or more cloves of garlic are positioned into the chamber and then the plier-like garlic press is pressed together. The pressing plunger immerses into the chamber and crushes the cloves of garlic located therein. At the same time garlic juice and a part of the flesh is pressed through the perforated base. The remains are pressed as a press-cake on the perforated base in the chamber. Running water usually does not rinse out the press-cake. The small size of the chamber and its depth also make difficult cleaning with a washing-up brush. Also, after washing in a dishwasher normally the press-cake is still located in the garlic press. Since with normal dishwashers subsequent to the washing procedure there is usually effected a drying procedure, thereafter the press-cake remaining in the garlic press sticks unpleasantly to the press. Washing in the dishwasher is desirable, not only for convenience, but also because there is a more intensive cleaning with relatively aggressive detergents, so that the last remains of the essential oils are removed and thus the garlic press after the cleaning is odorless.

Users typically scratch the press-cake out of the chamber using a sharp object, for example the tip of a knife, and then rinse out the press and finally place it into the dishwasher. This method is not particularly user-friendly and is not particularly hygienically sound.

### SUMMARY OF THE INVENTION

It is an object of this invention to provide a garlic press which has conventional functioning but which may be cleaned without any problem.

This object is achieved with a garlic press of the above-mentioned type but with a sieve-like, perforated base that can be separated from the chamber.

According to one preferred embodiment, the chamber is formed by a cylindrical section milled on one side perpendicular to a cylinder axis such that there an introduction slot is formed and at least approximately circumferentially there is present a contact edge, so that the perforated base is insertable into the introduction slot. Such embodiment has one advantage that there are no connection means needed to fasten the perforated base on the chamber.

Further advantageous embodiments of the subject-matter of this invention are discussed in the claims and their manner of functioning is explained in the subsequent description.

### BRIEF DESCRIPTION OF THE DRAWINGS

The drawings show one preferred embodiment of this invention, wherein:

FIG. 1 is a lateral view of a garlic press according to this invention;

FIG. 2 is a top view of the same garlic press shown in FIG. 1;

FIG. 3 shows a vertical longitudinal section of the garlic press;

FIG. 4 shows a rear view of the garlic press;

FIG. 5 shows a section taken through the chamber accommodating the product to be pressed, along line A-A in FIG. 1;

FIG. 6 shows a plan view of a base plate manufactured as one piece;

FIG. 7 shows a vertical section taken through the base plate according to FIG. 6 along line C-C; and

FIG. 8 is an enlarged view of detail B, as shown in FIG. 7.

### DESCRIPTION OF PREFERRED EMBODIMENTS

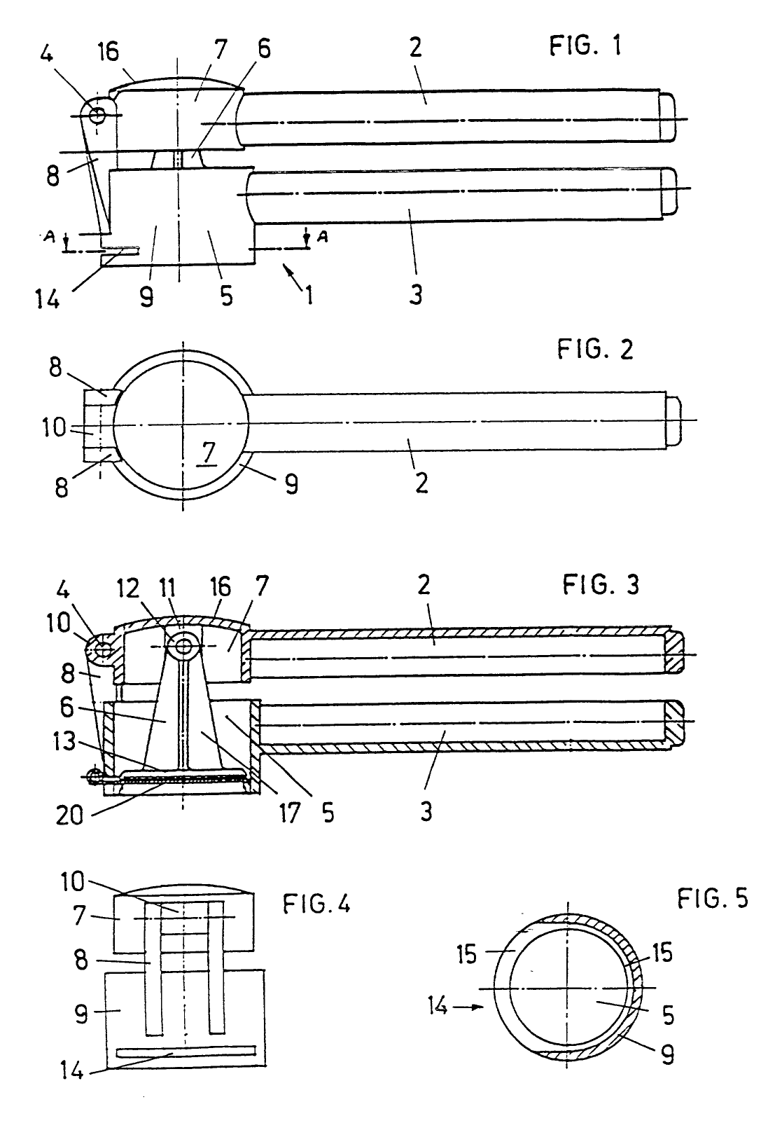

In FIG. 1 the garlic press is indicated in its entirety by element reference numeral 1, in a side view. The garlic press 1 has an upper grip 2 and a lower grip 3. The two grips 2 and 3 are linkedly joined to one another via a pivoting axis 4. The grips 2 and 3 may be formed as round rods or as shown in FIG. 3, as two U-shaped cross section profiles with open sides directed to one another. On the lower grip 3 there is formed as one piece a cylindrical section 9 which defines a chamber 5 in which the product to be pressed is accommodated. From below, the chamber 5 is limited by a sieve-like, perforated base plate 20. In the preferred embodiment the sieve-like base plate 20 is introduced within an introduction slot 14 milled into the cylindrical section 9.

On the upper grip 2 there is formed a head 7 of the press 1. The head 7 is basically formed as a cylindrical section and is closed by a curved covering 16. The head 7 of the press 1 is connected as one piece to the upper grip 2. In an inner space of the head 7 there is formed a bearing block 11 in which by way of a pressing plunger pivot 12 the press plunger 6 is linked to the upper grip 2. On the outer side of the head 7 of the garlic press 1 there is formed a pivot bearing 10. The pivot axis 4 passes through the pivot bearing 10 and corresponding bores in the consoles 8 which are formed as one piece on the cylindrical section 9 of the chamber 5. The two consoles 8 bear on the grips 2 and 3 diametrically opposite the wall of the chamber 5.

The pressing plunger comprises a pressing plunger plate 13 having a base surface corresponding to the cross-sectional surface of the chamber 5. The connection between the pressing plunger plate 13 and the pressing plunger pivot 12 is created by a pressing plunger connecting rod 17. The connecting rod 17 has a cross-shaped cross section in the embodiment shown. The connecting rod 17 tapers from the pressing plunger plate 13 to the pressing plunger pivot 12 and ends in a corresponding bearing socket led through the pressing plunger pivot 12.

FIG. 4 shows the rear view looking on the two consoles 8 and the pivot bearing 10. The introduction slot 14 is formed into the cylindrical section. The introduction slot 14 corresponds to a milled recess which runs perpendicular to the cylinder axis and which is dimensioned so that in the wall of the chamber 5 there is a contact edge 15. The contact edge 15 ensures a circumferential contact surface for the separably formed base plate 20.

The embodiment shown corresponds to the preferred form. It would also be possible to form the base plate 20 as an element capable of being coupled. Such a solution is not shown. Only in FIG. 3 is the base plate 20 shown inserted into the cylindrical section 9. In all other figures the base plate 20 is not shown in the inserted condition.

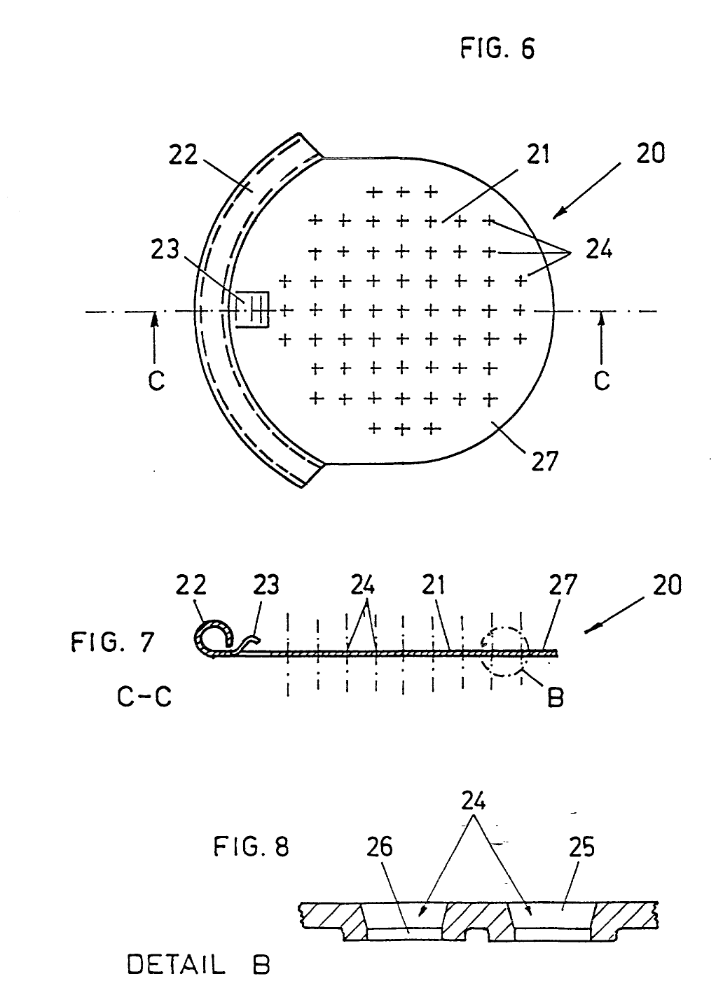

The base plate 20 is however shown by itself in detail in the FIGS. 6 to 8. FIG. 6 shows a view of the base plate 20. The base plate 20 has a perforated plate 21 and has a congruent shape of the cross section of the chamber 5 at the height of the introduction slot 14, as shown in FIG. 5. The perforated metal sheet 21 with the exception of the bead-like edge 22 may be completely introduced into the introduction slot 14. In the introduced condition the entire circumferential edge region 27 of the perforated plate 21 bears on the contact edge 15. In the completely inserted condition, a bead-like edge 22 at least approximately completely covers the outer region of the introduction slot 14. The bead-like edge 22 is directly formed by a winding-like deformation of the perforated plate 21. The perforation of the plate 21 is limited to the region which lies within the chamber 5. The edge region 27 which lies on the contact edge 15 is not perforated. Between the perforated region and the bead-like edge 22 in the plate 21 there is punched out a resilient tongue 23 which is bent upwards with respect to the surface. In the completely inserted condition the resilient tongue 23 rests directly on the inner side of the cylindrical section 9 of the chamber 5 and locks in position so that the base plate 20 is secured in the desired position. The base plate 20 however may be gripped on the bead-like edge 22, wherein under tension the resilient tongue 23 accordingly springs back and thus the sieve-like, perforated base plate 20 may easily be removed.

Apart from the form of the bead-like edge 22 shown it is also possible to design the bead-like edge 22 larger than the outer opening of the introduction slot 14, and specifically so that the bead 22 encompasses the cylindrical chamber 5 from outside by slightly more than half the circumference and thus with a complete insertion grasps the chamber in an encompassing and spring-elastic manner. Such a solution is particularly advantageous when the metal plate 21 and the bead-like edge 22 are manufactured of two separate parts, wherein the perforated sheet plate 21 is manufactured of metal and the bead-like edge 22 of plastic.

As mentioned, in one preferred manner the sieve-like, perforated base plate 20 with the bead-like edge 22 is formed from a piece of sheet. In a manufacturing procedure, the sheet is first pressed, then is punched and finally the bead is bent. These various working procedures may, as known, be accomplished in a multistage operation die. With this manufacturing technology the holes 24 may accordingly be formed with an upper conical hole region 25 which is directed towards the chamber and which merges into a cylindrical hole region 26 which accordingly ends in a sharp edge.

This design leads to an optimal de-juicing, without the clove of garlic being practically punched through the sieve-like, perforated base plate. Furthermore such a hole design has an advantage of improved cleaning.

With the separate design of the chamber and its sieve-like, perforated base plate the two parts may also be cleaned separately from one another. With this invention, it is no problem to take out the base plate, wherein the press-cake of the pressed-out cloves of garlic either remains lying fully on the base plate or on taking out is partly scraped off. The press-cake remaining on the base plate may be held directly under a running stream of water and accordingly washed off. If the rinsing alone is not sufficient, a brush can also be used. The entire garlic press 1 without the perforated base plate 20 may be placed directly into the dishwasher for cleaning. The base plate 20 may also be separately placed in the dishwasher for cleaning.

What is claimed is:

1. In a garlic press (1) having two plier-like hand grips connected to one another, wherein a chamber (5) is formed on a lower grip (3) and the chamber (5) accommodates a product to be pressed, a sieve-like perforated base, the upper grip (2) having a pressing plunger (6) immersing into the chamber (5), the improvement comprising: the sieve-like, perforated base formed as a base plate (20) separable from the chamber (5) of the lower grip (3).

2. In the garlic press according to claim 1, wherein the chamber (5) has a cylindrical section which on one side is milled perpendicular to a cylinder axis to form an introduction slot (14) and at least approximately circumferentially a contact edge (15) so that the perforated base plate (20) is insertable into the introduction slot (14).

3. In the garlic press according to claim 2, wherein a cross section of the cylindrical section is circular.

4. In the garlic press according to claim 2, wherein the sieve-like base plate (20) is punched as a perforated plate and comprises a bead-like edge (22) which at least partly covers the introduction slot (14).

5. In the garlic press according to claim 4, wherein the bead-like edge (22) is formed as one piece from the perforated plate of the base plate (20).

6. In the garlic press according to claim 4, wherein the bead-like edge (22) is a separate element connected to the perforated plate.

7. In the garlic press according to claim 3, wherein the base plate (20) has a punched resilient tongue (23) which in an inserted condition of the base plate (20) releasably locks on a wall of an inner side of the chamber (5).

8. In the garlic press according to claim 4, wherein the bead-like edge (22) encompasses in a resiliently releasable manner the chamber (5) from an outside and more than one-half of a circumference.

9. In the garlic press according to claim 1, wherein the base plate (20) has with conically narrowing holes (25).

10. In the garlic press according to claim 1, wherein the press plunger (6) is linked to the upper grip (2).

11. In the garlic press according to claim 3, wherein the bead-like edge (22) encompasses in a resiliently releasable manner the chamber (5) from an outside and more than one-half of a circumference.
